(19) United States
(12) Patent Application Publication
(10) Pub. No.: US 2010/0088310 A1
(43) Pub. Date: Apr. 8, 2010

(54) Method And System For Automating Data Queries During Discontinuous Communications

(75) Inventors: Joey L. Daugherty, Greenville, TX (US); Peter L. Stewart, Plano, TX (US); John N. Carbone, Garland, TX (US); Larry L. Johnson, Plano, TX (US); John C. Bendyk, Woodbridge, VA (US)

Correspondence Address: BAKER BOTTS L.L.P., 2001 ROSS AVENUE, SUITE 600, DALLAS, TX, 75201-2980, US

(73) Assignee: Raytheon Company, Waltham, MA (US)

(21) Appl. No.: 12/428,702

(22) Filed: Apr. 23, 2009

Related U.S. Application Data
(60) Provisional application No. 61/110,639, filed on Nov. 3, 2008.
(60) Provisional application No. 61/102,639, filed on Oct. 3, 2008.

(51) Int. Cl. G06F 17/30; G06F 15/16

(52) U.S. Cl. 707/722; 707/770; 707/E17.032; 707/E17.109; 709/227

(57) ABSTRACT

In accordance with one embodiment, a method includes receiving a query request comprising geospatial filter criteria. The query request may be received from a mobile client computing system capable of displaying query results as overlays on a digital map. The digital map may be stored at the mobile client computing system and the query results may be stored at a server. First and second portions of the query results may be wirelessly transmitted from the server to the mobile client computing system. The first and second portions may be transmitted during first and second communication sessions between the mobile client computing system and the server. The first and second communication sessions may occur during respective time intervals temporally separated from each other by a gap interval. The client may be capable of concatenating the transmitted first and second portions of the query results.

### RELATED APPLICATION

This application claims benefit under 35 U.S.C. § 119(e) of U.S. Provisional Application Ser. No. 61/110,639, entitled “DOCKABLE ENTERPRISE EXTENSION” filed Oct. 3, 2008, by Joey L. Daugherty et al.

### TECHNICAL FIELD

This disclosure generally relates to information systems, and more particularly, to a method and system for automating data queries during discontinuous communications.

### BACKGROUND

A geographical information system (GIS) is a type of computer executable system that enables the correlation and analysis of data based upon geo-spatially related criteria. A typical geographical information system in use today may include a window portion that is adapted for the display of a geographical map. Other forms of data may be overlaid on this map at their respective geographical locations in order to provide for efficient analysis of this data based upon its relative location on the map. Some geographical information systems may be queried according to various filter criteria.

### OVERVIEW

In accordance with one embodiment, a method includes receiving a query request comprising geospatial filter criteria. The query request may be received from a mobile client computing system capable of displaying query results as overlays on a digital map. The digital map may be stored at the mobile client computing system and the query results may be stored at a server. First and second portions of the query results may be wirelessly transmitted from the server to the mobile client computing system. The first and second portions may be transmitted during first and second communication sessions between the mobile client computing system and the server. The first and second communication sessions may occur during respective time intervals temporally separated from each other by a gap interval. The client may be capable of concatenating the transmitted first and second portions of the query results.

Depending on the specific features implemented, particular embodiments may exhibit some, none, or all of the following advantages. Various embodiments may be capable of automatically resuming a previously interrupted download without necessarily having to restart the download from scratch. Some systems may be capable of processing a query request for a client and/or routing query results intended for a client independent of whether or not the client is online. Some embodiments may use data compression for client/server transmissions, thereby possibly optimizing the use of some tactical networks that may have smaller bandwidth capabilities. Other technical advantages will be readily apparent to one skilled in the art from the following figures, description and claims.

### BRIEF DESCRIPTION OF THE DRAWINGS

A more complete understanding of the example embodiments will be apparent from the detailed description taken in conjunction with the accompanying drawings in which:

FIG. 1 is a block diagram showing several components of one embodiment of an automated data query system;

FIG. 2 shows a flowchart illustrating a series of actions that may be taken by various embodiments of the system of FIG. 1; and

FIG. 3 is a block diagram showing a portion of an automated data query system capable of using the several components of the system of FIG. 1 in a military application.

### DETAILED DESCRIPTION

A particular embodiment of the present disclosure may be described in the context of a military application. Some military units may use electronic devices that are capable of downloading strategic information regarding an area of operation. Such devices may also be capable of overlaying the downloaded information on a digital map display. Various tactical situations, however, may provide little or no time to interface with the device for purposes of inputting query requests or managing the download of query results. In addition, military units may use electronic devices in remote areas and/or during circumstances that permit only limited or intermittent communication with information sources.

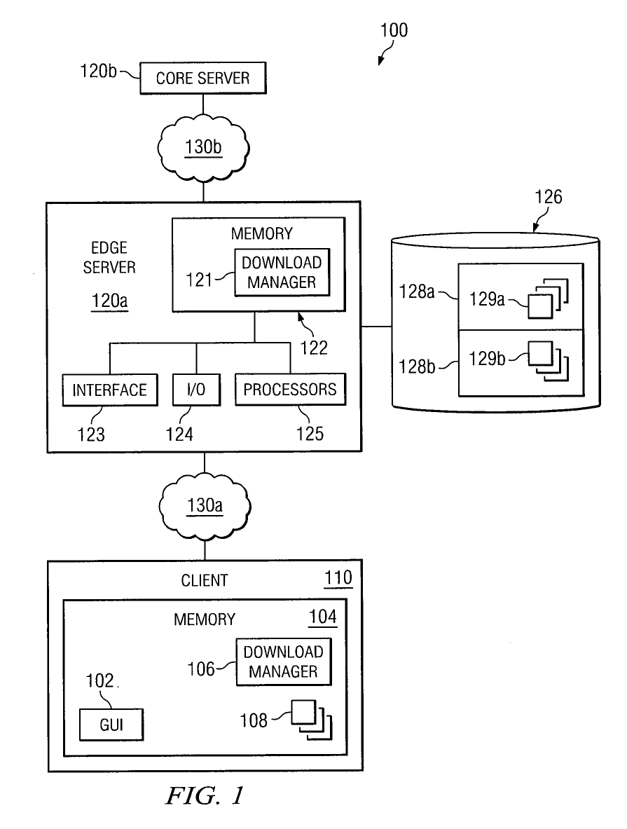

Particular embodiments of the present disclosure may automatically enable the downloading of strategic information by electronic devices in a manner that addresses the above considerations. For example, particular embodiments may automatically initiate queries such that a member of a military unit does not necessarily need to manually input query request parameters. The automated queries may include filters based on strategic areas of operation including, for example, the present locations and/or the future objectives of the military unit using the device. In addition, various embodiments may automatically manage the information downloads such that an interrupted download may be resumed at some later point as is if no interruption had taken place. Some interrupted downloads may resume automatically without necessarily requiring human input. The results returned from automated queries may be automatically updated such that the downloading device may have access to the latest data. Various embodiments of the present disclosure may be best understood by referring to FIGS. 1 through 3 of the drawings, like reference numerals being used for like and corresponding parts of the various drawings.

FIG. 1 is a block diagram showing several components of one embodiment of a portion of an automated data query system 100. The illustrated portion of automated data query system 100 generally includes one or more clients 110. Clients 110 are capable of communicating with one or more servers 120 through one or more networks 130. As explained further below, various embodiments of system 100 may be capable of performing automated data queries and seamlessly concatenating the query results from multiple download sessions. In some embodiments, the initiation of multiple download sessions may be automated by a particular client 110 or a particular server 120 during timeframes when the client/server communication may be intermittent or interrupted.

Each client 110 refers to any computing and/or communication device capable of enabling the communication of information to and/or from network(s) 130 or another component of system 100. For example, client 110 may be a laptop, a handheld device, some other mobile or non-mobile computing device, or a computer system that may be disposed in the console of a vehicle, such as an aircraft, naval vessel, or tank. In other embodiments client 110 is not readily mobile. Client 110 may be capable of enabling the communication of information (e.g., query request and/or query results) to and from servers 120 through network(s) 130.

In various embodiments, each client 110 may include software residing within memory 104 that when executed may be capable of enabling a user to interface with system 100 through client 110. For example, each client may include a Graphical User Interface 102 (GUI) that enables a user to input data queries and/or view results of data queries. In various embodiments, at least some of the query results may be displayed by client 110 as overlays on a graphical map based at least partially on one or more geospatial parameters of the results. GUI 102 may also provide a user with a status bar showing the progress of a download (e.g., in terms of percentage complete) and/or the strength of a communication signal. In particular embodiments, the GUIs 102 of some clients 110 may be Java enabled and executable using any suitable web browser, such as a Firefox, Internet Explorer, or Opera based web browser; however, any suitable GUI 102 may be used. In particular embodiments, a download manager 106 residing in memory 104 of client 110 may be capable of managing the download of one or more data files 129, as explained further below. Memory 104 may comprise any suitable volatile or nonvolatile storage and retrieval device or combination of devices. In various embodiments, memory 104 may comprise any combination of storage media. Additionally, all or part of memory 104 may reside locally within client 104 or could reside remotely from and accessible to client 104.

In some embodiments, the communication between a particular client 110 and a particular server 120 may be performed internally, such as, for example, via a system bus; or the communication between a particular client 110 and a particular server 120 may be through one or more wireless or wireline networks 130 and/or through one or more other servers 120. For example, one or more clients 110 may each be capable of communicating one or more requests through network 130a, which request(s) may be received and processed, for example, by server 120a using download manager 121.

Network(s) 130 may comprise any combination of wireless and/or wireline networks capable of supporting communication between network elements and/or between other components of system 100. For example, network 130a and/or network 130b may comprise a radio network (e.g., radio frequency (RF), ultra high frequency network (UHF), etc.), a cellular network, a satellite communications network (e.g., SATCOM, INMARSAT, etc.), a data network (e.g., Enhanced Position Location Reporting System (EPLRS)), a public switched telephone network (PSTN), an integrated services digital network (ISDN), a local area network (LAN), a wide area network (WAN), a metropolitan area network (MAN), all or a portion of the global computer network known as the Internet, any combination of the preceding, and/or other communication systems or combination of communication systems at one or more locations.

In this example, system 100 includes at least two servers 120a and 120b; however, any number of servers 120 may be used including, for example, a single server 120. Server(s) 120a may include any hardware, software, firmware, or combination thereof capable of enabling communication of information to and/or from network(s) 130 or another component of system 100. In various embodiments, servers 120a may include, for example, one or more directory servers, client servers, file servers, domain name servers, proxy servers, web servers, application servers, computer workstations, data repositories, routers, any combination of the preceding, or any other machine(s) or apparatus capable of enabling communication of information to and/or from network(s) 130 or another component of system 100. In the illustrated embodiment, server 120a includes memory 122, interface 123, input/output device 124, and one or more processors 125.

Memory 122 may comprise any suitable volatile or nonvolatile storage and retrieval device or combination of devices. In various embodiments, memory 122 may comprise any combination of storage media. Additionally, all or part of memory 122 may reside locally within server 120a or could reside remotely from and accessible to server 120a. Download manager 121, discussed further below, resides within memory 122 of server 120a. Download manager 121 may comprise software, firmware, data compilations, and/or a combination thereof

Interface 123 may comprise any device(s) that may be used (e.g., by a person, or by another device or system) to communicate with server 120a. For example, one or more keyboards or a mouse may be considered input interfaces of server 120a while monitors and printers may be considered output interfaces of server 120a. Input/output device 124 may refer to one or more devices capable of implementing the communication between server 120a and one or more other devices (e.g., one or more of clients 110, servers 120b, and/or another information processing system).

In this example, each server 120a is in communication with data storage 126. Data storage 126 represents one or more databases, computer components, devices, and/or recording media capable of retaining one or more data caches 128 of data files 129. In the illustrated embodiment, data storage 126 includes at least two data caches 128a and 128b located external to and accessible by server 126a; however, all or a portion of each data cache 128a and 128b may reside at any suitable location including, for example, at respective databases, at server 120a, and/or at some other server 120. Data storage 126 may comprise a magnetic data storage device (e.g., a diskette or a hard disk drive), an optical disc storage medium (e.g., a Laserdisc), a magneto-optical device (e.g., a MiniDisc), random access memory (RAM), or any other suitable volatile or nonvolatile storage and retrieval device or combination of devices. In a particular embodiment, data storage 126 includes an Oracle database partitioned into one or more data caches 128 capable of retaining data files 129 in the form of metadata, products, and/or maps associated with a particular query. At least some of the data files 129 may contain spatially-related information that may be managed by system 100 using any of a variety of relational database software including, for example, Arc Spatial Database Extension software (ArcSDE) by Environmental Systems Research Institute (ESRI).

The other illustrated server 120b of system 100 may include any hardware, software, firmware, or combination thereof capable of performing all or a portion of a data query and/or communicating the results of such a query to network(s) 130 and/or another component of system 100. In various embodiments, servers 120b may include, for example, one or more directory servers, client servers, file servers, domain name servers, proxy servers, web servers, application servers, computer workstations, data repositories, routers, any combination of the preceding, or any other machine(s) or apparatus capable of performing all or a portion of a query and/or communicating the results of such a query to network(s) 130 and/or another component of system 100. Some servers 120b may include a searchable metadata framework. In a particular embodiment, server 120b may additionally include structure and functionality substantially similar to that described previously with reference to server 120a and/or server 120a may additionally include structure and functionality substantially similar to that described above with reference to server 120b.

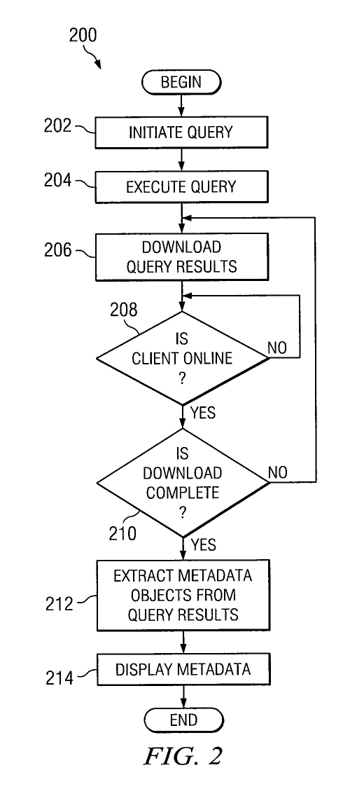

In operation, system 100 is generally capable of performing data queries and transmitting query results to clients 110 during one or more download sessions. Some data queries may be based at least partially on spatial, temporal, and/or contextual filter criteria regarding one or more geospatial areas of interest. Additional detail regarding the operation of some example embodiments of the present disclosure is described further with reference to FIG. 2.

FIG. 2 shows a flowchart 200 illustrating a series of actions that may be taken by various embodiments of system 100 of FIG. 1. The series of actions generally include initiating a query, executing the query, downloading query results during one or more download sessions, extracting metadata objects from query results, and displaying the metadata.

In act 202, a query is initiated. For example, a query may be initiated by generating, transmitting, modifying, and/or receiving a query request. Each query may be initiated at any suitable component of system 100 including, for example, at one or more clients 110 and/or servers 120. The initiation of a query may sometimes involve determining the location, or an expected location, of a particular client 110 and applying query filters accordingly.

In some embodiments, all or a portion of the query initiation of act 202 may be performed automatically. For example, system 100 may initiate the query in automatic response to a power-up sequence of the client 110. As a part of the power-up sequence, client 110 may determine its approximate location and automatically generate or otherwise modify the query filter criteria accordingly. Although some embodiments may generate filter criteria automatically, particular embodiments may provide additional or alternative query filter criteria in response to input received locally at client 110, such as, for example, in response to user input received via a client 110 interface.

In some embodiments, the initiation of a query may occur in act 202 during what may be considered as a first communication session between client 110 and one or more servers 120. For example, a particular server 120 may initiate the query in response to a transmission received directly from client 110 or indirectly from client 110 via or another server 120. Server 120 may automatically initiate the filter criteria of the query request based on a variety of factors including, for example, the time server 120 received the transmission from client 110, geospatial information received from client 110, an estimation of the client's 110 present location, an estimation of the client's 110 future location, a stored query procedure associated with client 110, filter criteria transmitted by client 110, and/or any of a variety of other factors.

The query is executed in act 204. For example, a query may be executed by searching metadata within one or more databases accessible to one or more servers 120. The search of metadata may be in accordance with spatial, temporal, and/or contextual filter criteria that, in some embodiments, may have been initiated in act 202. The execution of a query generally returns one or more query results. In some cases, system 100 may automatically and periodically update the query results of an executed query in anticipation of future transmission to a client 110 that may request information in accordance with the same query filter criteria.

At least a portion of the query results are downloaded in act 206. For example, a download may involve transmitting query results between servers 120 and/or from one or more servers 120 to client 110. Particular embodiments may manage the downloading of information from server 120 to client 110 using download managers 106 and/or 121.

In some embodiments, the components of system 100 that may be used to initiate a query in act 202 and/or execute a query in act 204 may not necessarily be the same components or the only components downloading the query results in act 206. For example, the result(s) of a query initiated at one or more servers 120 in act 202 may be downloaded by a particular client 110 in act 206 and/or the result(s) of a query initiated at one client 110 in act 202 may be downloaded by one or more other clients 110 in act 206.

In a particular embodiment, all or a portion of data file(s) 129 stored within data storage 126 and accessible to server 120 may contain at least some of the query results corresponding to a query initiated in act 202. The requesting client 110 may immediately download all or a portion of these available query results in act 206 if such results are available at server 120. Various communication disruptions, however, may inhibit or completely prevent clients 110 from downloading all or a portion of any query results immediately available at server 120. In addition, the data files 129 available at server 120, if any, may not be completely responsive to all of the information requested by clients 110. In some embodiments, server 120 may respond to a query request by downloading, in act 206, at least some of the requested information from an external source including, for example, from one or more other servers 120. Server 120 may store in storage 126 any information downloaded from an external source. This stored information may be transmitted to the requesting client 110 during one or more download sessions.

In some embodiments, query results may be transmitted between components of system 100 independent of the online status of a particular client 110 that ultimately downloads the query results in act 206. For example, one or more queries executed by server(s) 120b in act 204 may generate results of a query initiated by a particular client 110 in act 202. System 100 may select a server 120a that is expected to be located nearest to the requesting client 110 during an anticipated download of the query results by the requesting client 110. The selected server 120a may execute a download of the query results from server(s) 120b in act 206. Sever 120a may then store the downloaded data files 129 in data cache 128 for later retrieval by the requesting client 110. Routing query results from server(s) 120b to client 110 through a server 120a in this manner may enhance communication efficiency in some cases where the communication bandwidth through network 130b is greater than the available bandwidth of client/server network 103a.

Any of a variety of other techniques may be used to further enhance the communication efficiency between components of system 100 during downloads performed in act 206. For example, the server-side download manager 121 may be capable of digitally compressing at least some of the data files 129 downloaded by clients 110 and download manager 106 may be capable of decompressing data files 129 during or after the download process is complete. Any suitable compression/decompression algorithm(s) may be used including, for example, GNU zip (GZIP) compression. Transmitting digitally compressed files between clients 110 and servers 120 in this manner may not only increase the communication efficiency between these components, but may also enhance security by minimizing the possibility that third parties will be able to effectively interpret any information intercepted while in transit.

System 100 may be capable of enabling the download of query results by client 110 in act 206 even during timeframes when the communication between client 110 and other components of system 100 may be intermittent or interrupted. In some embodiments, the seamless concatenation of query results downloaded during one or more download sessions may be at least partially managed by download managers 106 and 121 residing at server 120a and client 110, respectively. For example, download managers 106 and/or 121 may monitor the progress of a download by client 110 of one or more data files 129 stored in data cache 128 of server 120a. If a download session is interrupted before 100% of the data file(s) 129 have been successfully downloaded by client 110, download managers 106 and/or 121 may store information (e.g., within memories 104 and/or 122, respectively) that when later retrieved enables client 110 to automatically resume the download precisely where it had left off In various embodiments, download mangers 106 and/or 121 may perform the management of downloads in an automated or semi-automated manner. In some embodiments, for example, download managers 106 and/or 121 may automatically pause the execution of a download in response to a detection that the receiving client 110 is no longer online; and download managers 106 and/or 121 may automatically enable the seamless continuation of a paused download in response to a detection that the receiving client 110 has resumed an online status as explained further with reference to act 208.

A determination is made in act 208 regarding whether the client 110 is online with respect to the particular server 120. As used herein, a first component is “online” with respect to a second component if the first component is ready and able to receive communications from the second component. In a particular embodiment, the act of determining whether client 110 is online with respect to server 120 may include, for example, transmitting a ping signal from server 120 to client 110 and monitoring at server 120 for an expected response. In some alternative embodiments, server 120 may determine whether client 110 is online by continually or periodically monitoring for one or more transmitted signals from client 110 without necessarily transmitting a ping signal to client 110. At least partially in response to a determination that client 110 is online, server 120 may transmit data packets containing query results for client 110 to download as described previously with reference to act 206.

If a determination is made in act 208 that client 110 is not online, however, server 120 may stop transmitting data packets to client 110 and may terminate a download session or, in some alterative embodiments, server 120 may pause and maintain a download session until another determination may be made that client 110 has resumed an online status. Any of a variety of factors may cause or contribute to an interrupted communication between client 110 and server 120, which interruption may result in client 110 having an offline status. For example, client 110 may be turned off, incapable of transmitting a signal that is detectable by server 120, outside the radiation pattern of a signal transmitted by server 120, or otherwise not capable of detecting a transmitting signal from server 120. At some point, however, client 110 may resume an online status with respect to server 120.

Upon a determination, in act 208, that client 110 is once again online with respect to server 120, server 120 may resume a paused download session at a point where it had left off or, in some alternative embodiments, server 120 may initiate a new download session and transmit a data packet that client 110 may have not yet downloaded, or that client 110 may have only partially downloaded, in a previous download session.

In act 210, a determination is made regarding whether the download is complete. For example, download managers 106 and/or 121 may continually monitor the progress of a download of one or more query results, which download may include multiple download sessions. The download sessions may be temporally separated from each other by one or more time intervals during which time client 110 may not necessarily be online with respect to server 120.

If it is determined that the query results are completely downloaded, client 110 may extract metadata objects from the query results in act 212 and display the metadata objects as information overlaid on a map in act 214. For example, client 110 may store the query results downloaded in act 206 within memory 104 as data file(s) 108. At least some of the stored data file(s) 108 may include spatial information, which when extracted may be represented by GUI 102 as objects overlaying a display map. In some embodiments, client 110 may store multiple maps within memory 104 as data file(s) 108 and client 110 may include software configured to display the map portion of the data file(s) 108, thereby enabling a variety of geospatial backdrops that may be used to display any metadata extracted from the query results in act 212. By retrieving data file(s) 108 and/or maps stored within memory 104, client 110 may thus be capable of spatially displaying filtered information to a user regarding one or more geospatial areas of interest regardless of the online status of client 110 with respect to other components of system 100.

Some or all of the example acts of flowchart 200 associated with initiating a query, executing the query, downloading query results during one or more download sessions, extracting metadata objects from query results, and displaying the metadata may be implemented automatically by systems 100 without a user necessarily having to manually input query request parameters, reestablish a communication session, and/or provide any other instruction. In particular embodiments, some or all of the example acts of flowchart 200 may be initiated in response to a power-up sequence of client 110.

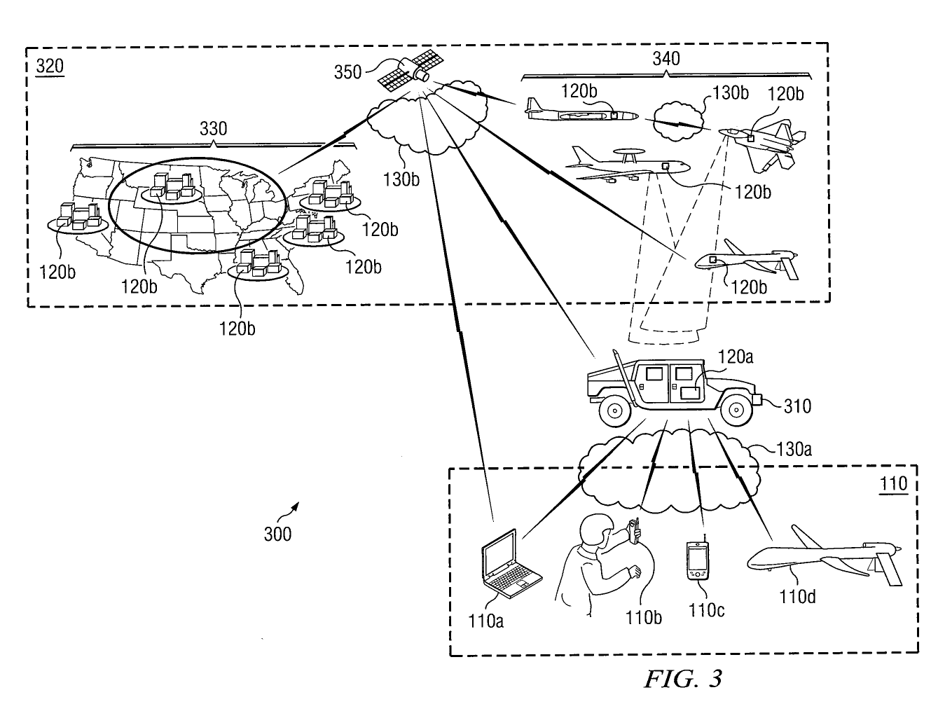

Additional detail regarding the operation of one embodiment of system 100 may be explained in the context of a military application that involves automatically querying and seamlessly communicating strategic information for mobile clients 110 in use by military units, as explained further with reference to FIG. 3.

FIG. 3 is a block diagram showing a portion of an automated data query system 300 capable of using the several components of the system 100 of FIG. 1 in a military application. In this example, system 300 generally includes multiple mobile clients 110a, 110b, 110c, and 110d capable of downloading information from one or more servers 120a at a local site 310 and/or from a network enterprise 320. The server 120a at local site 310 is generally capable of storing query results and routing query results from network enterprise 320 to clients 110. Network enterprise 320 generally includes one or more servers 120b located at stationary information centers 330. Each server 120b of the stationary information centers 330 is connected through network(s) 130 to one or more servers 120b disposed in mobile routers 340. The system 300 illustrated in FIG. 3 may operate in a tactical environment that may sometimes permit only intermittent communication between the components of system 300 (e.g., client/server, client-to-client, and/or server-to-server communications).

In this example, clients 110a, 110b, 110c, and 110d are a laptop computer, a cell phone, a handheld computer, and an unmanned drone, respectively. Each client 110 is capable of communicating query requests and downloading query results for any of a variety of military applications. For example, a solider may wish to query any of the following types of information: the location and composition of enemy units and/or friendly units relative to one or more battlefield maps stored on client 110; the location and nature of civilian installations in a particular area of interest; and/or some other type of information regarding a specific area of operation. In some embodiments, the solider may input queries by typing specific filter criteria using an interface of client 110, such as, for example, a keyboard or a keypad.

The soldier may alternatively input or otherwise modify a query by pressing one or more functional buttons of client 110. For example, the press of a power button on client 110 may trigger a power-up sequence that includes the transmission of a request for data. System 300 may respond to this request by executing or otherwise modifying a preconfigured query procedure in accordance with an approximate location or an estimated future location of the powered-on client 110 as determined by system 300, and/or system 300 may respond by commencing or resuming the downloading of query results by the powered-on client 110. Some functional buttons may be preconfigured or programmable such that their selection transmits query requests having particularized filters. For example, some functional buttons may request specific information regarding enemies and/or allies that may be overlaid on a battlefield map. The transmission of query requests and/or the downloading of query results by client 110 through the use of functional buttons may minimize the time the soldier spends interfacing with client 110, which may provide a tactical advantage in some situations.

In this example, local site 310 is a military vehicle that is positioned proximate to clients 110a, 110b, 110c, and 110d and that contains one or more server(s) 120a capable of communicating wirelessly with clients 110a, 110b, 110c, and 110d and with the various components of network enterprise 320. Local site 310 may respond to query requests from clients 110 by transmitting any query results already available to local site 310 upon detection that the requesting client 110 is online. In addition, local site 310 may respond to a query request by retrieving at least some of the requested information from an external source including, for example, network enterprise 320 or from the server(s) 120a of another local site 310.

In this example, network enterprise 320 includes one or more stationary information centers 330 connected through one or more networks 130 to one or more mobile routers 340. Stationary information centers 330 generally refer to any of a variety of searchable information repositories residing at military bases. One example of a stationary information center 330 may include multiple servers 120b residing at the United States Strategic Air Command Base (SAC).

Each mobile router 340 generally refers to any suitable military vehicle capable of transmitting information to particular communication zones that may encompass local site 310 and/or clients 110. Some mobile routers 340 may also include one or more servers 120b capable of executing data queries and/or storing query results. In the illustrated example, each mobile router 340 is a military aircraft (e.g., a Lockhead U-2); however, any suitable land-based or water-based mobile router 340 may be used.

Network enterprise 320 also includes network(s) 130 capable of communicatively coupling the various components of network enterprise 320 to each other and to local site 310. The network(s) 130 illustrated in FIG. 3 include one or more satellites 350, each of which may enable communication between each stationary information center 330 and each mobile router 340. In addition, each satellite 350 of network(s) 130 may be capable of enabling direct communication between a particular client 110 and a server 120b of network enterprise 320 without necessarily routing the communication through local site 310.

In the context of a military application, a solider may input a request using client 110 and then the soldier may be exposed to a combat situation during which time communication between client 110 and local site 310 may become disrupted. Thus, client 110 may not necessarily be online with respect to local site 310 during all or a potion of the time interval lasting from the moment client 110 transmitted the request to the moment client 110 determined that all or a portion of the requested information is available at local site 310. Regardless of whether or not client 110 remains online, local site 310 may store any query results received from network enterprise 320 and/or another local site 310 in preparation for subsequent downloading by client 110 during one or more time intervals when 110 is online with respect to local site 310. In addition, local site 310 may periodically and/or automatically determine whether any data that local site 310 may have downloaded from an external source has been subsequently updated or otherwise modified by the external source; and local site 310 may modify any corresponding data files 129 stored in data storage 126 accordingly.

If client 110 does not maintain an online status with respect to local site 310 after transmitting a request, at some point client 110 may reestablish communication with local site 310, determine that local site 310 has some or all of the requested information, and then download all or a portion of the available information accordingly. In particular embodiments, client 110 may determine that local site 310 has modified all or a portion of a data file 129 previously downloaded and stored by client 110; and in response, client 110 may download all or a portion of the modified data file 129 and update the client's 110 stored data file(s) 108 accordingly. As explained previously with reference to FIGS. 1 and 2, if a download is interrupted, client 110 may later resume the download as if the interruption had not occurred.

Thus, system 300 may provide any of a variety of advantages in the context of a military application. For example, a solider using client 110 in a time critical situation will not necessarily have to restart an interrupted download from scratch. In addition, system 300 may perform a bulk of the query processing and data transmission independent of whether or not client 110 is online with respect to servers 120 that may be located at local site 310 or network enterprise 320. The downloading of information by client 110 from local site 310 may be independent of whether or not local site 310 is online with respect to servers 120 external to local site 310. Particular embodiments using data compression for all or some of the client/server transmissions may be advantageous for the portions of network(s) 130 that may have lower bandwidth capabilities. For example, some tactical “soda straw” networks 130 enabling communication between clients 110 and local site 310 may average as little as five kilobits per second.

It should also be noted that where a flowchart is used to demonstrate various aspects of particular embodiments, it should not be construed to be limited to any particular logic flow or logic implementation. The described logic may be partitioned into different logic blocks (e.g., programs, modules, functions, or subroutines) without changing the overall results. Often, logic elements may be added, modified, omitted, performed in a different order, or implemented using different logic constructs (e.g., logic gates, looping primitives, conditional logic, and other logic constructs).

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, JavaScript, or HTML) for use with various operating systems or operating environments, including future operating systems or environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). In a particular embodiment, all or a portion of the various software applications used to implement at least some of the acts of system 100 may be embodied in any of a variety of other suitable computer-readable medium, such as, for example, removable media.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A computer-implemented system for executing queries, the system comprising:
one or more servers each operable to:
process at least a respective portion of a query request, the query request comprising geospatial filter criteria; and
generate one or more respective query results corresponding to the query request;
a local server coupled to each of the one or more servers through a first wireless network and operable to receive and store each of the one or more respective query results; and
a mobile client computer system communicatively coupled to the server through a second wireless network, the mobile client computing system operable to:
transmit the query request through the second wireless network to the local server during a first communication session between the mobile client computing system and the local server;
receive first and second portions of the one or more respective query results, the first portion received during a second communication session between the mobile client computing system and the local server, the second portion received during a third communication session between the mobile client computing system and the local server, the second and third communication sessions occurring during respective time intervals temporally separated from each other by a gap interval, the third communication session initiated automatically by the mobile client computing system or the local server;
concatenate the received first and second portions of the one or more respective query results;
extract metadata objects from the concatenated first and second portions of the one or more query results;
render a map from data stored at the mobile client computing system, the data different from the received first and second potions of the one or more respective query results; and
display as overlays on a map the extracted metadata objects, the map rendered by a display screen of the mobile client computing system from data stored at the mobile client computing system independent of the received first and second portions of the one or more query results.

2. The computer-implemented system of claim 1, wherein a second server of the one or more servers is disposed in the console of a vehicle selected from the group consisting of:
a land-based vehicle;
a water-based vehicle; and
an aircraft.

3. The computer-implemented system of claim 1, wherein the mobile client computing system is further operable to automatically initiate the third session with the local server at least partially in response to a power-up sequence of the mobile client computing system.

4. The computer-implemented system of claim 1, wherein the mobile client computing system comprises an interface comprising one or more buttons each associated with a respective preconfigured query procedure.

5. A method comprising:
wirelessly transmitting a query request comprising geospatial filter criteria, the query request transmitted during a first wireless communication session between a mobile client computing system and a server;
wirelessly receiving at the mobile client computing system first and second portions of one or more query results corresponding to the query request, the first portion received during a second communication session between the mobile client computing system and the server, the second portion received during a third communication session between the mobile client computing system and the server, the second and third communication sessions occurring during respective time intervals temporally separated from each other by a gap interval, the third communication session initiated automatically by the mobile client computing system or the server;
concatenating by the client the received first and second portions of the one or more query results corresponding to the query request;
extracting metadata objects from the concatenated first and second portions of the one or more query results corresponding to the query request;
rendering a map from data stored at the mobile client computing system, the data different from the received first and second portions of the one or more query results; and
displaying as overlays on the map the extracted metadata objects.

6. The method of claim 5, further comprising automatically initiating the third session at least partially in response to a detection by the server that the mobile client computing system is ready to receive transmissions from the server.

7. The method of claim 5, further comprising automatically initiating the third session by the mobile client computing system at least partially in response to a power-up sequence of the mobile client computing system.

8. The method of claim 5, wherein the first and second communication sessions occur during respective time intervals separated by a second gap interval.

9. The method of claim 5, wherein the query request is transmitted automatically in response to a power-up sequence of the mobile client computing system.

10. The method of claim 5, further comprising inputting the query request at the mobile client computing system using one or more buttons each associated with a respective preconfigured query procedure.

11. The method of claim 5, further generating the query results by executing the query request using one or more databases accessible to the server

12. The method of claim 5, further comprising downloading at the server the one or more query results corresponding to the query request, the one or more query results downloaded by the server from one or more other servers capable of executing the query request using one or more databases accessible to the one or more other servers.

13. The method of claim 5, further comprising persistently storing the one or more query results at the server and at the mobile client computing system.

14. A method comprising:
receiving a query request comprising geospatial filter criteria;
storing at a server one or more query results corresponding to the query request; and
wirelessly transmitting first and second portions of the one or more query results from the server to a mobile client computing system, the first portion received during a first communication session between the mobile client computing system and the server, the second portion received during a second communication session between the mobile client computing system and the server, the first and second communication sessions occurring during respective time intervals temporally separated from each other by a gap interval, the mobile client computing system capable of concatenating the transmitted first and second portions.

15. The method of claim 14, wherein the first and second portions of the one or more query results are each transmitted automatically in response to respective detections by the server that the mobile client computing system is ready to receive transmissions from the server.

16. The method of claim 14, further comprising downloading at the server the one or more query results corresponding to the query request, the one or more query results downloaded by the server from one or more other servers capable of executing the query request.

17. The method of claim 14, further comprising:
determining the approximate location of the mobile client computing system; and
filtering the one or more query results based at least partially on the determination of the approximate location of the mobile client computing system.

18. The method of claim 14, further comprising storing at the server the one or more query results corresponding to the query request.

19. The method of claim 14, wherein the first and second portions of the one or more query results are each transmitted automatically in response to a detection that the mobile client computing system is ready to receive transmissions from the server.

20. The method of claim 14, further comprising automatically initiating, by the mobile client computing system or by the server, the second communication session.
